(19) United States
(12) Patent Application Publication
(10) Pub. No.: US 2025/0339235 A1
(43) Pub. Date: Nov. 6, 2025

(54) LATHE ADAPTER ASSEMBLY FOR DENTAL POLISHING

(71) Applicant: WRMDSV IV, LLC, Charleston, SC (US)

(72) Inventors: Walter G. Renne, Charleston, SC (US); Michael DeFee, Charleston, SC (US)

(21) Appl. No.: 18/656,463

(22) Filed: May 6, 2024

(51) Int. Cl. A61C 3/06; A61C 13/00; B24D 5/16

(52) U.S. Cl. CPC A61C 3/06; A61C 13/0024; B24D 5/16

(57) ABSTRACT

A lathe adaptor assembly for mounting at least one polishing wheel to a spindle of a dental lathe. The lathe adaptor assembly comprises a first retention bolt with a hollow interior, a hollow bolt head, a reinforced internal structure, and an exteriorly-threaded end for engaging the spindle to secure the lathe adaptor assembly, a second retention bolt also featuring a hollow interior and an exteriorly-threaded end, and a center carrier equipped with a central throughbore designed to mount a first polishing wheel and a second polishing wheel, each secured by friction to prevent rotation on the center carrier.

### FIELD OF THE DISCLOSURE

The present disclosure relates generally to dental polishing, and more particularly, to a lathe adaptor assembly for a dental polishing unit or dental polishing lathe which can be attached to the lathe's spindle to increase the number of polishing wheels on the unit.

### BACKGROUND OF THE DISCLOSURE

Dental polishing lathes are used for refining and finishing various dental appliances, including dentures, crowns, bridges, orthodontic appliances, and other dental prosthetics. They are primarily employed to achieve a smooth and polished surface on these devices, enhancing their appearance, fit, and comfort for the patient. Dental professionals use polishing lathes to remove imperfections, excess material, and rough surfaces from dental restorations, ensuring they meet the required specifications and provide optimal functionality. Additionally, polishing lathes allow for the application of polishing agents or compounds, which help achieve a glossy finish and improve the aesthetic quality of the dental appliances.

Conventional dental polishing lathes comprise several components, such as arbors, a shank, and polishing wheels. The motor serves as the powerhouse, driving the rotation of the polishing wheels attached to the shank or spindle by the arbors. These arbors securely hold the polishing wheels in place while allowing for controlled rotation. The shank or spindle provides stability and support, ensuring alignment of the polishing wheels during the polishing process.

Switching polishing wheels on a dental polishing lathe involves several steps to ensure proper alignment and functionality. First, the lathe must be powered off and unplugged to prevent accidents. Then, the arbor nut holding the current polishing wheel in place must be loosened and removed along with any washers. Extracting the old polishing wheel can be challenging due to its snug fit on the arbor shaft. Sometimes the use of other tools such as a hammer or pliers may be necessary which could potentially damage the arbor and wheels.

Accordingly, there is need for a solution to at least one of the aforementioned problems. For instance, there is an established need for a faster and straightforward way to polish dental appliances like crowns, dentures, and bridges, without having to swap the polishing wheels.

### SUMMARY OF THE DISCLOSURE

The present disclosure is directed to a lathe adaptor assembly for polishing lathes which can be attached to the arbor to double the number of polishing wheels in polishing lathes. The lathe's adapter may comprise a center carrier. The center carrier may be configured for attachment to the lathe's spindle. A first retention bolt can threadably engage the center carrier and spindle to retain the lathe adaptor assembly in place. The first retention bolt may be hallowed with reenforced internal structure to accommodate the spindle. Accordingly, in an exemplary application, a retention bolt can be attached to each side of the center carrier, such as a first retention bolt and a second retention bolt.

In a first implementation of the disclosure, a lathe adaptor assembly for increasing the number of polishing wheels in a polishing lathe comprises a center carrier with internal threads and hollowed interior. The center carrier is configured for connection to a polishing wheel retention bolt and a polishing wheel. The lathe adaptor assembly further comprises a first retention bolt and a second retention bolt. The first and second retention bolts can be threadably engaged to each end of the center carrier. The second retention bolt may comprise a bolt head adapted for the application of a torque on the bolt head.

In another aspect, the first and second retentions bolt can be rotationally and axially movable within the center carrier. Axial movement of the first and second retention bolts within the center carrier can be limited.

These and other objects, features, and advantages of the present disclosure will become more readily apparent from the drawings and the detailed description of the preferred embodiments.

### BRIEF DESCRIPTION OF THE DRAWINGS

The preferred embodiments of the disclosure will hereinafter be described in conjunction with the appended drawings provided to illustrate and not to limit the disclosure, where like designations denote like elements, and in which:

FIG. 1 presents a view of the assembled lathe adaptor assembly depicting a pair of lathe adaptor assembly connected to a dental lathe as an illustrative aspect of the present disclosure;

FIG. 2 presents a view of the assembled lathe adaptor assembly depicting a polishing dental lathe with a lathe adaptor assembly securing polishing wheels on each side of the center carrier and polishing a dental appliance as an illustrative aspect of the present disclosure;

FIG. 3 presents an exploded isometric view of the lathe adaptor assembly illustrated in FIG. 1, as an illustrative aspect of the present disclosure;

FIG. 4 presents an angled exploded isometric view of the lathe adaptor assembly illustrated in FIG. 1, as an illustrative aspect of the present disclosure;

FIG. 5 presents an exploded isometric view of the center carrier with its hollowed inside and internal threads and the second retention bolt with its external threads as an illustrative aspect of the present disclosure; and

FIG. 6 presents an exploded isometric view of the lathe adaptor assembly illustrated in FIG. 1, as an illustrative aspect of the present disclosure.

Like reference numerals refer to like parts throughout the several views of the drawings.

### DETAILED DESCRIPTION

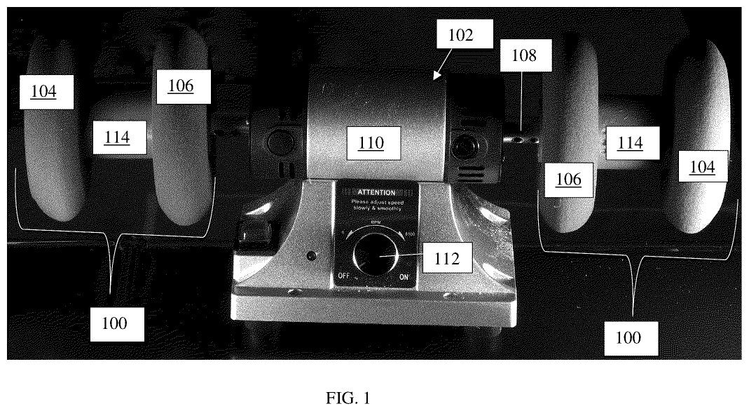

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the disclosure as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present disclosure is directed toward a lathe adaptor assembly which can be attached to a dental polishing lathe to polish dental appliances.

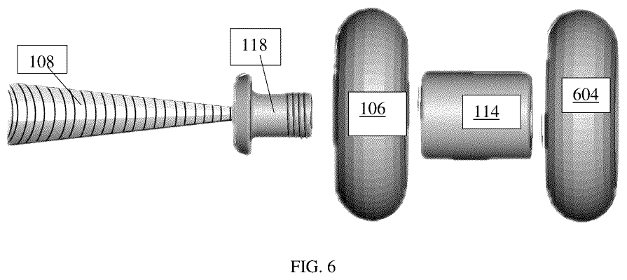

Referring initially to FIGS. 1-6, a lathe adaptor assembly, hereinafter lathe adaptor assembly 100, for a dental polishing lathe 102 is illustrated in accordance with an exemplary embodiment of the present disclosure. Turning to FIG. 1, the dental polishing lathe 102 comprises a motor 110 that drives the spindle 108 and an on-off switch 112. The spindle 108 can be a rigid shaft that extends outwardly from the motor 110, and the motor 110 may be configured to comprise a spindle 108 extending outwardly from a distal end and proximal end of the motor 110, as FIG. 1 exemplifies. The spindle 108 is rotated by the motor 110 and can have a tapered end (See FIG. 6).

The lathe adaptor assembly 100 comprises a first retention bolt 118, a second retention bolt 120, and a center carrier 114. The center carrier 114 can provide support and alignment for other components that are mounted or engaged with it. A first polishing wheel 104, and a second polishing wheel 106 can be mounted on, or engaged with, the center carrier 114. Other components can comprise the first polishing wheel 104 and the second polishing wheel 106.

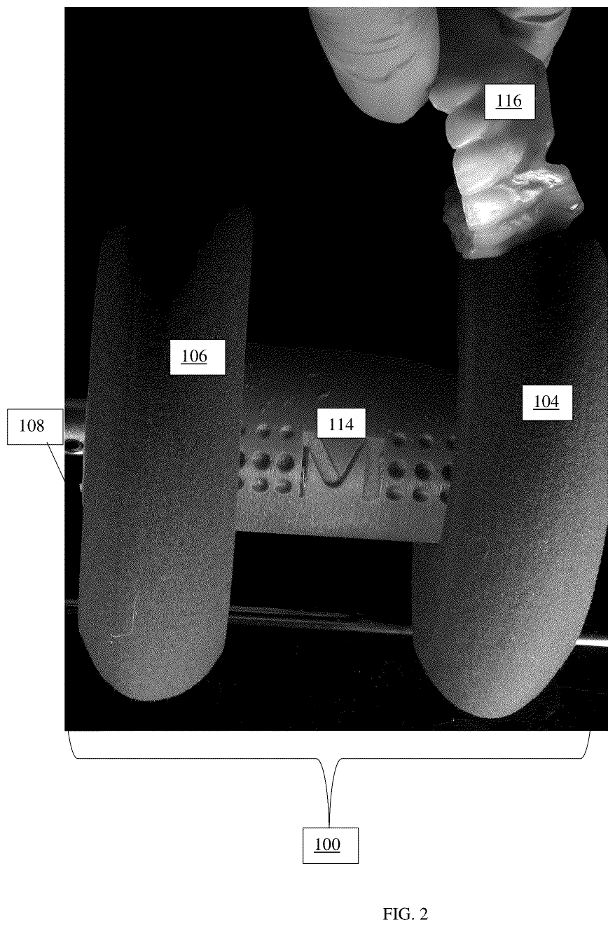

Turning to FIG. 2, an exemplary aspect of the lathe adaptor assembly 100 is shown. The center carrier 114 can be cylindrical in shape and comprise a central throughbore 138 (See FIG. 5) for accepting at least a portion of the spindle 108. The center carrier 114 can be a length that allows the first polishing wheel 104 to be a distance away from the second polishing wheel 106 that allows a user to polish, for example, a dental prothesis 116, without the dental prothesis 116 or the user's hand touching both the first polishing wheel 104 and the second polishing wheel 106 at the same time. The lathe adaptor assembly 100 can be affixed to the dental polishing lathe 102 by means of the spindle 108, facilitated by the first retention bolt 118. The center carrier 114 can also be rectangular or block, triangular, or polygonal in shape. This disclosure is not intended to be limited by the shape of the center carrier 114.

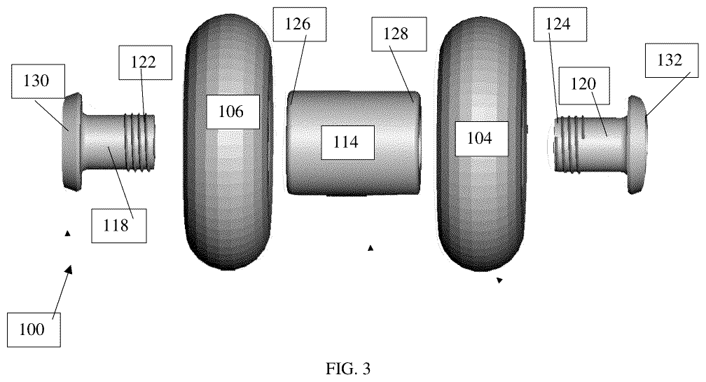

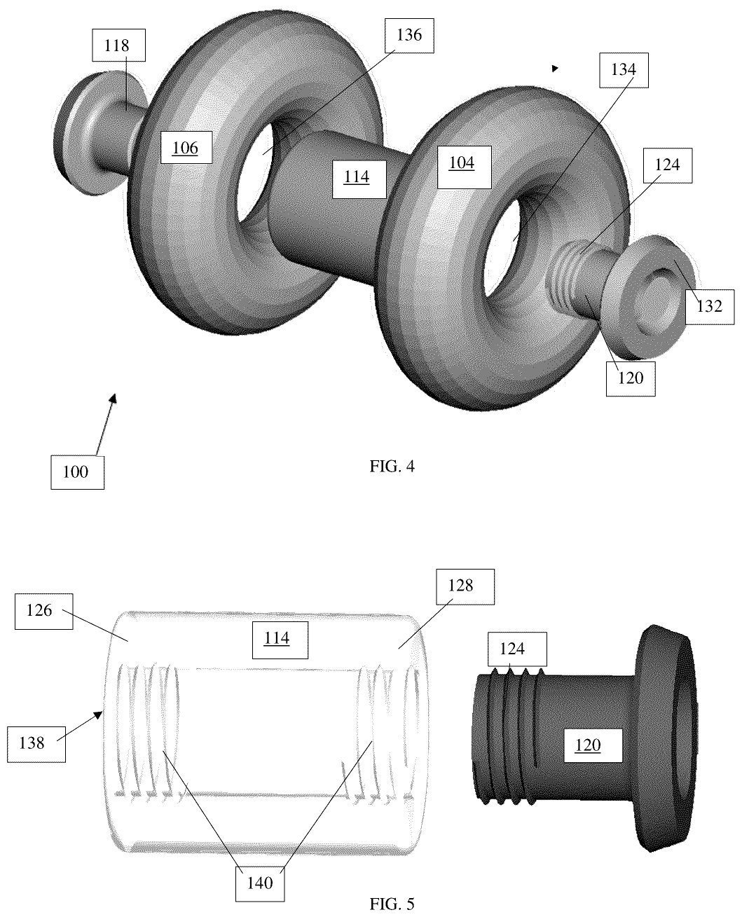

As exemplified in FIGS. 3 and 4, the lathe adaptor assembly 100 can comprise a first retention bolt 118 comprising an exteriorly-threaded end 122, a second retention bolt 120 comprising an exteriorly-threaded end 124, and the center carrier 114. The first retention bolt 118 being positioned to engage the interiorly-threaded proximate end 126 of the center carrier 114, and the exteriorly-threaded end 124 being positioned to engage the interiorly-threaded proximate end of the center carrier 114. The term “exteriorly-threaded” refers to the threads on first retention bolt 118 and on the second retention bolt 120, which establishes a male threaded connection. The first retention bolt 118 and the second retention bolt 120 can comprise a hollow interior that extends through the head of each bolt, 130 and 132. The first polishing wheel 104 can comprise a central opening 134 and the second polishing wheel 106 can comprise a central opening 136 for accepting the center carrier 114. The central opening 134 of first polishing wheel 104 and central opening 136 of the second polishing wheel 106 can be dimensioned to precisely fit around the exterior circumference of the center carrier 114 to hold them in place and prevent them from spinning on the center carrier 114.

Turning to FIG. 5, an exemplary aspect of the center carrier 114 is provided. The center carrier 114 comprises interiorly-threaded ends 126 and 128, and a central throughbore 138. The interiorly-threaded proximate end 126 can be fastened or joined to the exteriorly-threaded end 122 of the first retention bolt 118, and the interiorly-threaded distal end 128 can be fastened or joined to the exteriorly-threaded end 124 of the second retention bolt 120. The term “interiorly-threaded” denotes that the interior thread 140 facilitates a female threaded connection.

Turning to FIG. 6, an exemplary aspect of the present disclosure is shown. The first retention bolt 118 can be joined or affixed to the spindle 108 by sliding it onto the spindle. The spindle 108 is shown with a tapered end, though this disclosure is not intended to be limited to spindles with tapered ends.

A method for mounting at least one polishing wheel to a spindle of a dental lathe using a lathe adaptor assembly is also disclosed. The method can comprise sliding a first retention bolt 118 comprising a hollow interior, a hollow bolt head, a reinforced internal structure, and an exteriorly-threaded end 122 over an end of the spindle 108, wherein the first retention bolt 118 is slid to a position on the spindle 108 where it cannot be slid any further of a distance onto the spindle 108. The method can comprise rigidly securing the first retention bolt 118 to the spindle 108, wherein the first retention bolt 118 is rigidly secured to the spindle 108 by pressure and friction. Rigidly securing a proximate end 126 of a center carrier 114 to the exteriorly-threaded end 122 of the first retention bolt can be accomplished by twisting the center carrier 114 or the first retention bolt 118. Another step in the method can comprise rigidly securing an exteriorly-treaded end of a second retention bolt to a distal end 128 of the center carrier 114, wherein the center carrier 114 comprises a central throughbore 138 (see FIG. 5) with interior threading 140 (see FIG. 5) at both ends.

The method can also comprise rigidly mounting a second polishing wheel 106 on the center carrier 114, wherein the second polishing wheel 106 can be positioned proximate to a proximate end 126 of the center carrier 114. Rigidly mounting the second polishing wheel 106 can be accomplished by securing it with or by friction. The method can also comprise mounting a second polishing wheel 106 proximate to the interiorly-threaded distal end 128 of center carrier 114 and rigidly mounting the first polishing wheel 104 can be accomplished by securing it with or by friction.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the disclosure should be determined by the appended claims and their legal equivalents.

We claim:

1. A lathe adaptor assembly for mounting at least one polishing wheel to a spindle of a dental lathe, the lathe adaptor assembly comprising:
a first retention bolt comprising a hollow interior, hollow bolt head, a reinforced internal structure, and an exteriorly-threaded end, wherein the first retention bolt engages the spindle of the dental lathe to affix the lathe adaptor assembly to the dental lathe;
a second retention bolt having a hollow interior, and an exteriorly-threaded end; and
a center carrier comprising a central throughbore and configured for mounting a first polishing wheel and a second polishing wheel thereon, wherein the first polishing wheel and the second polishing wheel are secured by friction to prevent them from spinning on the center carrier.

2. The lathe adaptor assembly of claim 1, wherein the center carrier is 0.5-6 inches in diameter.

3. The lathe adaptor assembly of claim 1, wherein the center carrier comprises a hollow internal diameter 1/16ths to 3 inches.

4. The lathe adaptor assembly of claim 1, wherein the first retention bolt is 0.5-6 inches long.

5. The lathe adaptor assembly of claim 1, wherein the center carrier comprises internal threads on each end for engaging with threads on the first retention bolt and the second retention bolt.

6. The lathe adaptor assembly of claim 1, wherein a portion of the spindle extends through the first retention bolt and into the center carrier.

7. The lathe adaptor assembly of claim 1, further comprising a first polishing wheel mounted on the center carrier, wherein the first polishing wheel is positioned proximate to a proximate end of the center carrier.

8. The lathe adaptor assembly of claim 1, further comprising mounting a second polishing wheel mounted on the center carrier, wherein the second polishing wheel is positioned proximate to a distal end of the center carrier.

9. A method for mounting at least one polishing wheel to a spindle of a dental lathe using a lathe adaptor assembly, the method comprising:
sliding a first retention bolt comprising a hollow interior, a hollow bolt head, a reinforced internal structure, and an exteriorly-threaded end over an end of the spindle, wherein the first retention bolt is slid to a position on the spindle where it cannot be slid any further;
rigidly securing the first retention bolt to the spindle, wherein the first retention bolt is rigidly secured to the spindle by pressure and friction;
rigidly securing a proximate end of a center carrier to the exteriorly-threaded end of the first retention bolt; and
rigidly securing an exteriorly-treaded end of a second retention bolt to a distal end of the center carrier, wherein the center carrier comprises a central throughbore with interior threading at both ends.

10. The method of claim 9, further comprising rigidly mounting a first polishing wheel on the center carrier, wherein the first polishing wheel is positioned proximate to a proximate end of the center carrier.

11. The method of claim 10, wherein the rigidly mounting is secured by friction.

12. The method of claim 10, further comprising mounting a second polishing wheel on the center carrier, wherein the second polishing wheel is positioned proximate to a distal end of the center carrier.

13. The method of claim 12, wherein the rigidly mounting is secured by friction.

14. A lathe adaptor assembly for mounting at least two polishing wheels to a spindle of a dental lathe, the lathe adaptor assembly comprising:
a first retention bolt comprising a hollow interior, hollow bolt head, a reinforced internal structure, and an exteriorly-threaded end, wherein the first retention bolt engages the spindle of the dental lathe to affix the lathe adaptor assembly to the dental lathe;
a second retention bolt having a hollow interior, hollow bolt head, and an exteriorly-threaded end; and
a center carrier being cylindrical in shape and comprising internal threads on either end for engaging threads on the first retention bolt and second retention bolt, a central throughbore and configured for mounting a first polishing wheel and a second polishing wheel thereon, wherein the first polishing wheel and the second polishing wheel are secured by friction to prevent them from spinning on the center carrier.

15. The lathe adaptor assembly of claim 14, wherein a portion of the spindle extends through the first retention bolt and into the center carrier.

16. The lathe adaptor assembly of claim 15, further comprising a first polishing wheel mounted on the center carrier, wherein the first polishing wheel comprises a central opening that dimensioned to precisely fit around an exterior circumference of the center carrier and is positioned proximate to a proximate end of the center carrier.

17. The lathe adaptor assembly of claim 16, further comprising mounting a second polishing wheel mounted on the center carrier, wherein the second polishing wheel comprises a central opening that dimensioned to precisely fit around the exterior circumference of the center carrier and is positioned proximate to a proximate end of the center carrier.
